(19) United States
(12) Patent Application Publication
(10) Pub. No.: US 2025/0273996 A1
(43) Pub. Date: Aug. 28, 2025

(54) MULTI-PHASE WIRELESS POWER TRANSFER SYSTEMS

(71) Applicant: The Texas A&M University System, College Station, TX (US)

(72) Inventors: Hamid A. Toliyat, College Station, TX (US); Yuming Chen, College Station, TX (US)

(73) Assignee: The Texas A&M University System, College Station, TX (US)

(21) Appl. No.: 19/064,495

(22) Filed: Feb. 26, 2025

Related U.S. Application Data
(60) Provisional application No. 63/557,951, filed on Feb. 26, 2024.

(51) Int. Cl. H02J 50/12; H02J 50/40; H02J 50/90

(52) U.S. Cl. CPC H02J 50/12; H02J 50/402; H02J 50/90

(57) ABSTRACT

A power supply includes a first section couplable to a source of electrical power, and includes a first compensation circuit, and a first coil having a first coil main area. The power supply includes a second section including a second coil separated from the first coil by a gap and having a second coil main area. The second coil main area is oppositely facing and aligned with the first coil main area to allow wireless power transfer from the first coil to the second coil. The second section includes a second compensation circuit, and a rectifier to provide direct current power to a load. The second section is oppositely oriented to the first section to reduce rotational misalignment.

### CROSS-REFERENCE TO RELATED APPLICATION

This application claims the benefit of U.S. Provisional Patent Application No. 63/557,951, entitled “A Misalignment Resistant Multi-Phase Wireless Power Transfer Coil,” filed Feb. 26, 2024, which is incorporated herein by reference.

### TECHNICAL FIELD

The present disclosure is directed, in general, to power electronics and, more specifically, to multi-phase wireless power transfer systems and methods of operating the same.

### BACKGROUND

For conventional multi-phase wireless power transfer coils, achieving an optimal power rating necessitates precise alignment of both transmitter and receiver windings at specific angles. The phenomenon characterized by any deviation in orientation between the transmitter and receiver is denoted as rotational misalignment. In the realm of multi-phase wireless power transfer systems, rotational misalignment can precipitate a decline in power ratings and operational efficiency. This issue is pervasive in various applications such as multi-phase wireless charging for drones. In scenarios such as this, a wireless charging station may assume an uncertain orientation with respect to the drone's receiver, owing to the unpredictability inherent in the landing process.

The conventional solutions for the rotational misalignment issue is to use single-phase wireless power transfer coils. However, achieving equivalent power levels necessitates subjecting single-phase wireless power transfer coils to higher voltage and current stress compared to their multi-phase counterparts. This constraint impedes the applicability of single-phase wireless power transfer systems in high-power applications. What is needed is a wireless power transfer system that overcomes the deficiencies of the prior art.

### SUMMARY

Deficiencies of the prior art are generally solved or avoided, and technical advantages are generally achieved, by advantageous embodiments of the present disclosure of multi-phase wireless power transfer systems and methods of operating the same. In one embodiment, a power supply of a wireless power transfer system includes a first section couplable to a source of electrical power, and includes a first compensation circuit, and a first coil of a multi-phase coil configuration and having a first coil main area. The power supply also includes a second section including a second coil of the multi-phase coil configuration separated from the first coil by a gap and having a second coil main area. The second coil main area is oppositely facing and aligned with the first coil main area to allow wireless power transfer from the first coil to the second coil. The power supply also includes a second compensation circuit, and a rectifier configured to provide direct current power to a load. The second section is oppositely oriented to the first section to reduce rotational misalignment therebetween.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, reference is now made to the following detailed description taken in conjunction with the accompanying drawings, in which:

FIG. 1 illustrates a diagram of an embodiment of a wireless power transfer system;

FIG. 2 illustrates a diagram of a flux hot spot 210;

FIG. 3 illustrates a top view of a multi-phase coil configuration 300 of a power supply of a wireless power transfer system;

FIG. 4 illustrates a top view of a multi-phase coil configuration 400 of a power supply of a wireless power transfer system;

FIG. 5 illustrates a cross-sectional view of coupled coils of a multi-phase coil configuration of a power supply 500 of a wireless power transfer system;

FIG. 6 illustrates an isolated top view of phase winding A of a multi-phase coil configuration 600 of a power supply of a wireless power transfer system;

FIG. 7 illustrates a schematic diagram demonstrating a series combination of the phase windings A, B, and C;

FIG. 8 illustrates a power supply 800 of a wireless power transfer system;

FIG. 9 illustrates a view of a multi-phase coil configuration of a power supply 900 of a wireless power transfer system;

FIGS. 10A and 10B illustrate a top view and bottom view, respectively, of a multi-phase coil configuration 1000 of a power supply of a wireless power transfer system;

FIG. 11 illustrates a graphical representation of mutual inductances M_{Aa}, M_{Ab}, and M_{Ac};

FIG. 12 illustrates a graphical representation of the inverter output voltages;

FIG. 13 illustrates a graphical representation of the input currents of the transmitter's inductor-capacitor-capacitor to series compensation circuit;

FIG. 14 illustrates a graphical representation of dc load voltage (output voltage) and current when the wireless power transfer system is in the aligned condition; and

FIG. 15 illustrates a graphical representation of de load voltage (output voltage) of a wireless power transfer system.

Corresponding numerals and symbols in the different figures generally refer to corresponding parts unless otherwise indicated and, in the interest of brevity, may not be described after the first instance.

### DETAILED DESCRIPTION

A multi-phase coil configuration designed for a wireless power transfer system (“WPTS”) is disclosed herein. The multi-phase coil configuration includes multi-phase wireless power transfer systems that address rotational misalignment challenges with higher power ratings and less voltage and current stress on the coils. The technology can be applied to, for instance, supercharging for battery-powered devices including electric vehicles such underwater vehicles like autonomous underwater vehicles (“AUVs”). Example applications for the electric vehicles include ocean science, industrial exploration and military applications. The energy source are typically batteries, and the battery charging solutions for underwater vehicles include battery replacement, underwater charging with cables, and underwater charging with wireless power transfer (“WPT”).

WPT has emerged as a convenient and efficient method for charging AUVs. Compared to single-phase WPT, implementing multi-phase WPT such as three-phase WPT on AUVs may take advantage of the three-phase system, which can enhance power transfer capabilities. However, traditional three-phase wireless charging encounters power reduction issues with rotational misalignments, especially in close-coupled conditions like AUVs. The WPTS disclosed herein includes a rotational misalignment resistant multi-phase coil configuration. In the design, the phase windings are evenly distributed to mitigate the output voltage reduction caused by rotational misalignment. The design permits AUVs to dock at arbitrary angles with underwater wireless charging stations. Verification shows that the design can transfer power with output direct current (“dc”) voltage fluctuations of less than five percent (“%”) under rotational misalignment conditions.

Autonomous underwater vehicles, a subset of unmanned underwater vehicles (“UUVs”), have become increasingly prevalent in the fields of ocean science, industrial exploration, and military applications. (See, e.g., R. W. Button, et al., “A survey of missions for unmanned undersea vehicles,” RAND Corp. Nat. Def. Res. Inst., Santa Monica, CA, USA, 2010. Accessed: May 11, 2018. [Online]. Available: http://www.rand.org/pubs/research_briefs/RB9539.html, which is incorporated herein by reference.) The AUVs come equipped with a range of sensors, including sonar, side scan sonar, salinity and temperature sensors, buoyancy materials, cables, lights, cameras, navigation systems, and communication systems. (See, e.g., C. R. Teeneti, T. T. Truscott, D. N. Beal and Z. Pantic, “Review of Wireless Charging Systems for Autonomous Underwater Vehicles,” in IEEE Journal of Oceanic Engineering, vol. 46, no. 1, pp. 68-87, January 2021, which is incorporated herein by reference.)

The AUVs usually rely on batteries to power their propulsion and onboard sensor systems, facilitating autonomous operation for several hours to several days. (See, e.g., H. Yoshida, “Fundamentals of underwater vehicle hardware and their applications,” in Underwater Vehicles. Rijeka, Croatia: InTech, 2009, which is incorporated herein by reference.) However, the need for frequent recharging remains a challenge. Battery replacement serves as a convenient solution when AUVs are docked in ports or can be accessed by motherships. (See, e.g., L. D. Adams and D. A. White, “Technical overview of a safe, configurable, pressure tolerant, subsea lithium ion battery system for oil and gas deep water fields,” in Proc. OCEANS Conf., 2013, pp. 1-8, which is incorporated herein by reference.) In cases where underwater recharging is required, WPT has emerged as a widely accepted solution.

WPT has gained increasing popularity across a variety of applications due to its non-contact power transmission capabilities. (See, e.g., G. A. Covic and J. T. Boys, “Inductive Power Transfer,” in Proceedings of the IEEE, vol. 101, no. 6, pp. 1276-1289 June 2013, which is incorporated herein by reference.) It has found utility in diverse sectors including consumer electronics (see, e.g., D. van Wageningen and T. Staring, “The Qi wireless power standard,” Proceedings of 14th International Power Electronics and Motion Control Conference EPE-PEMC 2010, pp. SI5-25-S15-32, 2010, which is incorporated herein by reference), electric vehicles (see, e.g., S. Li and C. C. Mi, “Wireless Power Transfer for Electric Vehicle Applications,” in IEEE Journal of Emerging and Selected Topics in Power Electronics, vol. 3, no. 1, pp. 4-17, March 2015, which is incorporated herein by reference), and medical implants (see, e.g., A. Iqbal, A., et al., “Wireless power transfer system for deep-implanted biomedical devices.” Sci Rep 12, 13689, 2022, which is incorporated herein by reference).

In the context of underwater charging for AUVs, WPT presents a favorable alternative to wired charging methods. Wired charging necessitates the establishment and maintenance of physical wire connections, potentially introducing challenges in AUV structural design. Specifically, an inadequately designed AUV body may give rise to issues such as water leakage or insulation problems. In contrast, incorporating WPT into the hull design of an AUV offers a more straightforward solution.

Recently, there is a growing interest in the application of WPTS for AUVs. In a study by Z. Cheng, Y. Lei, K. Song and C. Zhu, “Design and Loss Analysis of Loosely Coupled Transformer for an Underwater High-Power Inductive Power Transfer System,” in IEEE Transactions on Magnetics, vol. 51, no. 7, pp. 1-10, July 2015 (which is incorporated herein by reference), a single-phase magnetic core structure is introduced for AUV charging. However, the rectangular shape of this design presents challenges in terms of the docking mechanism and could potentially affect power transfer efficiency in underwater environments. Another approach, detailed in Z. Yan, K. Zhang, H. Wen and B. Song, “Research on characteristics of contactless power transmission device for autonomous underwater vehicle,” OCEANS 2016-Shanghai, Shanghai, China, 2016 (which is incorporated herein by reference), features a single-phase WPT design with an arc-shaped core, which simplifies integration into the AUV hull. Nonetheless, this method necessitates precise alignment of the AUV with the charging station during the docking process, limiting the AUV's approach from various directions.

In a different study, Z. Li, D. Li, L. Lin, and Y. Chen, “Design considerations for electromagnetic couplers in contactless power transmission systems for deep-sea applications,” J. Zhejiang Univ. Sci. C, vol. 11, no. 10, pp. 824-834, October 2010 (which is incorporated herein by reference) presented a wireless charging prototype using a pot core. S. Wang, B. Song, G. Duan, and X. Du, “Automatic wireless power supply system to autonomous underwater vehicles by means of electromagnetic coupler,” J. Shanghai Jiaotong Univ., vol. 19, no. 1, pp. 110-114, February 2014 (which is incorporated herein by reference) developed a relatively loosely coupled system with a six to ten millimeter (“mm”) gap between the transmitter and receiver coil. Furthermore, Q. Gao, X. Wu, J. Liu, and Z. Yang, “Modeling and simulation of contactless power transformers for underwater application,” in Proc. Int. Conf. Mechatronics Autom., 2009, pp. 1213-1217 (which is incorporated herein by reference) explored the power transfer capabilities of different pot core surface shapes, comparing flat and cone-shaped surfaces, and revealed that the cone-shaped core exhibited better resistance to offset.

So far, these aforementioned WPTS for AUVs are single phase WPTS. However, there is a growing trend towards adopting multi-phase WPTS due to their distinct advantages, including enhanced power transfer capability and the ability to provide a relatively steady instantaneous power output. (See, e.g., J. Colussi, et al., “100 kW Three-Phase Wireless Charger for EV: Experimental Validation Adopting Opposition Method,” Energies 2021, 14, 2113; J. Pries, V. P. N. Galigekere, O. C. Onar and G.-J. Su, “A 50-kW Three-Phase Wireless Power Transfer System Using Bipolar Windings and Series Resonant Networks for Rotating Magnetic Fields,” in IEEE Transactions on Power Electronics, vol. 35, no. 5, pp. 4500-4517 May 2020; M. Mohammad, J. L. Pries, O. C. Onar, V. P. Galigekere, G.-J. Su and J. Wilkins, “Three-Phase LCC-LCC Compensated 50-kW Wireless Charging System with Non-Zero Interphase Coupling,” 2021 IEEE Applied Power Electronics Conference and Exposition (APEC), Phoenix, AZ, USA, 2021, pp. 456-462; K. Kusaka, R. Kusui, J. Itoh, D. Sato, S. Obayashi and M. Ishida, “A 22 kW-85 kHz Three-phase Wireless Power Transfer System with 12 coils,” 2019 IEEE Energy Conversion Congress and Exposition (ECCE), Baltimore, MD, USA, 2019, pp. 3340-3347; A. D. Brovont, D. Aliprantis, S. D. Pekarek, C. J. Vickers and V. Mehar, “Magnetic Design for Three-Phase Dynamic Wireless Power Transfer With Constant Output Power,” in IEEE Transactions on Energy Conversion, vol. 38, no. 2, pp. 1481-1484 June 2023; Y. Chen and H. A. Toliyat, “A Reconfigurable LCC-P/S Compensated Three-Phase Wireless Charging Topology with Constant Current and Constant Voltage Output,” 2023 IEEE Applied Power Electronics Conference and Exposition (APEC), Orlando, FL, USA, 2023, pp. 788-794, which are incorporated herein by reference.)

The stability is valuable for minimizing output fluctuations and proves advantageous for subsequent power supplies on the receiver's end. Furthermore, as demonstrated by J. Zhou, D. Li, and Y. Chen, “Frequency selection of an inductive contactless power transmission system for ocean observing,” Ocean Eng., vol. 60, pp. 175-185, March 2013 (which is incorporated herein by reference), WPTS encounter increased eddy current losses when transferring power through seawater compared to air. In contrast to single-phase systems, multi-phase WPTS require lower flux density between the transmitter and receiver to transfer the same amount of power, a characteristic that is particularly advantageous for WPT when operating through seawater. (See, e.g., A. U. Ibrahim, W. Zhong and M. D. Xu, “A 50-kW Three-Channel Wireless Power Transfer System With Low Stray Magnetic Field,” in IEEE Transactions on Power Electronics, vol. 36, no. 9, pp. 9941-9954 September 2021, which is incorporated herein by reference.)

However, multi-phase WPTS may encounter challenges related to rotational misalignment. As an AUV approaches a wireless charging station situated on the seabed, its docking orientation may vary due to factors such as the underwater terrain, water currents, and the station's placement. Employing a mechanical positioning system for precise alignment to overcome this challenge can significantly increase the cost of the system. Consequently, ensuring the power transfer capability remains reliable under conditions of rotational misalignment becomes imperative when applying multi-phase WPTS to AUVs.

In a previous study, T. Kan, R. Mai, P. P. Mercier and C. C. Mi, “Design and Analysis of a Three-Phase Wireless Charging System for Lightweight Autonomous Underwater Vehicles,” in IEEE Transactions on Power Electronics, vol. 33, no. 8, pp. 6622-6632 August 2018 (which is incorporated herein by reference) introduced a three-phase system for AUVs, incorporating a circular three-phase coil embedded within the AUV's hull. However, as previously mentioned, it also faces the issue of rotational misalignment. Therefore, the WPTS introduced herein acknowledges the limitations of previous research and presents a multi-phase wireless charging solution tailored for, as an example, AUVs specifically designed to address the rotational misalignment concerns.

The WPTS presents a circular disc-shaped (ring-shaped) multi-phase WPT coil design for charging battery-powered electronics, addressing the challenge of rotational misalignment. The design delves into a detailed breakdown and analysis of the coil structure. Through circuit-level analysis, the research establishes that the design can consistently deliver power output regardless of the docking angle. A design utilizes a compensation circuit known as the inductor-capacitor-capacitor to series (“LCC-S”). The design includes the establishment of an inductance matrix for various misalignment angles. Again, the results indicate that output voltage reduction remain within five percent of the rated output voltage.

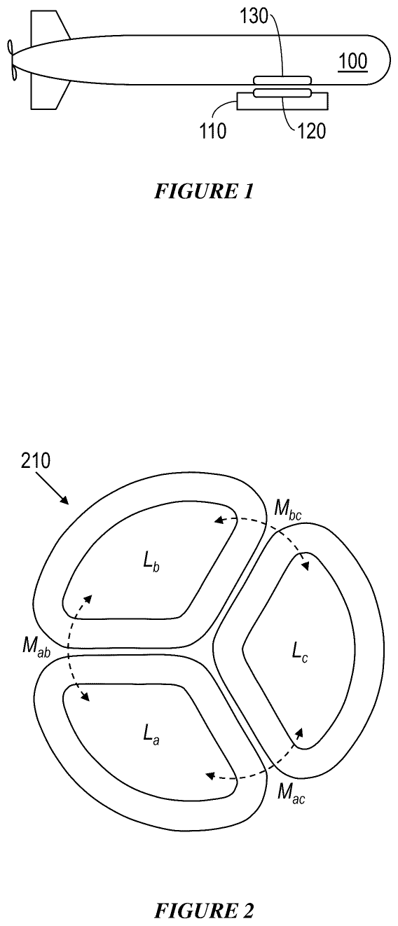

FIG. 1 illustrates a diagram of an embodiment of a wireless power transfer system. In this case, the wireless power transfer system is employed for battery-powered devices such an autonomous underwater vehicle 100. The wireless transfer power system includes a power supply with multiple sections and a multi-phase coil configuration. A first section of the power supply is resident on a wireless charging station 110 and includes a transmitter coil 120 of the multi-phase coil configuration. A second section of the power supply is resident on the autonomous underwater vehicle 100 and includes a receiver coil 130 of the multi-phase coil configuration. The integration of the multi-phase coil configuration into the wireless power transfer system has the capacity to elevate power ratings expediting the battery charging process. Moreover, the inherent rotational misalignment resistant feature enables stable power transfer ratings under flexible underwater docking directions.

FIG. 2 illustrates a diagram of a flux hot spot 210. The coefficient L represents the inductance per phase and the coefficient M represents the mutual inductance between phases. The flux hot spots 210 should be aligned to obtain efficient (e.g., maximum) power transfer capability.

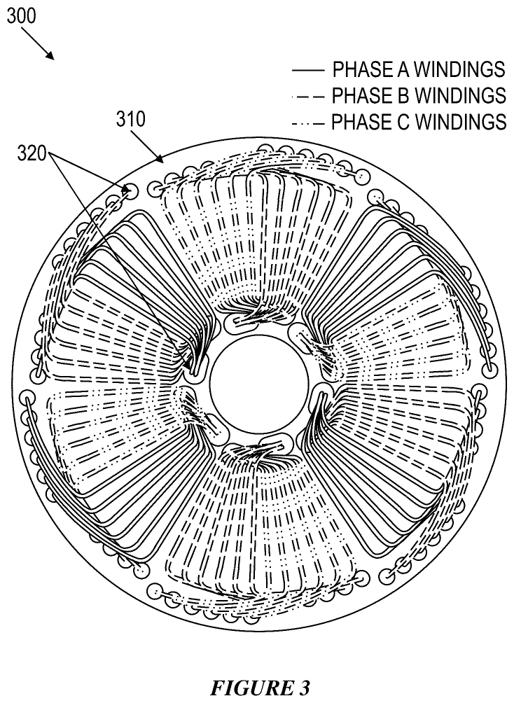

FIG. 3 illustrates a top view of a multi-phase coil configuration 300 of a power supply of a wireless power transfer system. The phase windings are placed on a three dimensional (“3D”) printed wire guide 310. The phase windings A are the phase windings depicted as a solid lines. The phase windings B are the phase windings depicted as a dashed lines. The phase windings C are the phase windings depicted as a double dashed lines. The multi-phase coil configuration 300 is designed to resist rotational misalignment. The circular plate representing the 3D printed wire guide incorporates slots and holes (terminals, ones of which are designated 320) to secure the wires in their designated positions. A completed WPTS includes two identical multi-phase coil configurations 300 depicted in FIG. 3. One coil is situated on the wireless charging station, while the other is carried by the battery-power devices.

The multi-phase coil configuration 300 includes one or multiple windings for each phase, with the potential incorporation of magnetic cores such as ferrite cores to enhance the coupling. The distribution of turns across all phase windings is generally uniform on a main surface or area. Also, there is an overlap among the phase windings. With these features, the multi-phase coil configuration 300 provides a solution to the power transfer reduction problem of WPTS due to rotational misalignment issues.

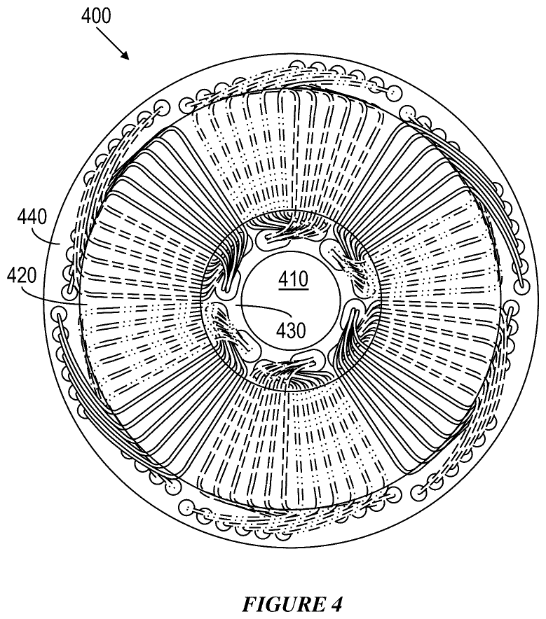

Given that a phase winding is distributed partially within the main area and partially within the auxiliary area (see FIG. 4), the wires situated within the main area are generally uniformly spaced from one another. Conversely, the wires traversing the auxiliary area are not subjected to any specific constraints. Consider an example where a circular main area is employed, each wire constituting the entire coil is arranged linearly along the radial direction, maintaining a consistent separation angle between adjacent wires.

The phase windings exhibit partial overlapping with each other. As an illustrative example, in the event that the concluded phase winding A encompasses a specific spatial domain, it is important that a domain enveloped by the phase winding B partially intersects with the region enclosed by the phase winding A.

FIG. 4 illustrates a top view of a multi-phase coil configuration 400 of a power supply of a wireless power transfer system. The multi-phase coil configuration 400 is segmented into main and auxiliary areas. A central region 410 is an auxiliary area that serves as a docking area, intentionally left vacant to facilitate the docking mechanism. Surrounding the central region 410, there is a ring that encompasses the main area 420. The main area 420 includes the phase windings A, phase windings B and phase windings C similar to the phase windings illustrated and described with respect to FIG. 1. Within this main area 420, the phase windings of the transmitter and the receiver are closely coupled, resulting in a higher coupling factor. As a result, the main area 420 functions as the primary location for most of the wireless power transfer. The end-winding regions (an inner end-winding region 430 and an outer end-winding region 440) are also auxiliary areas that provide a pathway for the phase windings to traverse back and forth through the main area 420.

Thus, the multi-phase coil configuration 400 is partitioned into two functional regions, the main area(s) and the auxiliary area(s). The phase windings of the multi-phase coil configuration 400 are distributed within both of these areas, with each phase winding occupying a partial extent within the main area(s) 420 and the end-winding areas 430, 440 of the auxiliary area(s), respectively. For a transmitter and receiver pair, the phase winding sections located in the main area 420 exhibit a superior coupling coefficient compared to those in the end-winding areas 430, 440 of the auxiliary areas. This is how these two areas are identified. This feature can be realized by methods including, but not limited to, a reduction of a gap between the main areas 420 of the transmitter and receiver coils, with an augmentation of a gap between end-winding areas 430, 440 of the auxiliary areas, and manipulation of the positioning of the magnetic cores.

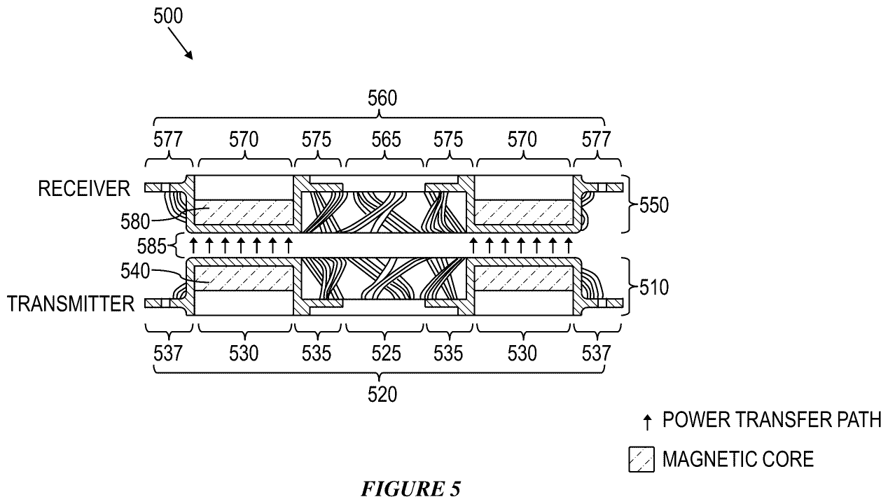

FIG. 5 illustrates a cross-sectional view of coupled coils of a multi-phase coil configuration of a power supply 500 of a wireless power transfer system. The power supply 500 includes a first section (also referred to as a “transmitter section”) 510 and a second section (also referred to as a “receiver section”) 550 oppositely oriented with respect to the first section 510. The transmitter section 510 includes a transmitter coil 520 like the multi-phase coil configuration 400 introduced with respect to FIG. 4. The transmitter coil 520 includes transmitter coil main and auxiliary areas. The transmitter coil auxiliary area includes a central region 525 that serves as a docking area, and transmitter coil end-winding regions (inner end-winding regions 535 and outer end-winding regions 537) that flank (surround or border) the transmitter coil main areas 530. The transmitter section 510 also includes a transmitter magnetic core 540 such a ferrite magnetic core. Of course, other magnetic materials can be used for the magnetic core 540.

Similarly, the receiver section 550 includes a receiver coil 560 like the multi-phase coil configuration 400 introduced with respect to FIG. 4. The receiver section 550 is oppositely oriented with respect to the transmitter section 510. The receiver coil 560 includes receiver coil main and auxiliary areas. The receiver coil auxiliary area includes a central region 565 that serves as a docking area, and receiver coil end-winding regions (inner end-winding regions 575 and an outer end-winding regions 577) that flank (surround or border) the receiver coil main areas 570. The receiver section 550 also includes a receiver magnetic core 580 such a ferrite magnetic core. Of course, other magnetic materials can be used for the magnetic core 580.

The transmitter and receiver magnetic cores 540, 580 are positioned directly beneath (or under) the transmitter and receiver coil main areas 530, 570 of the transmitter coil 520 and the receiver coil 560, respectively. The transmitter and receiver magnetic cores 540, 580 assume the same ring-shaped configuration as the respective transmitter and receiver coil main areas 530, 570. The transmitter and receiver magnetic cores 540, 580 play a role in enhancing coupling coefficients. Both the transmitter coil 520 and the receiver coil 560 are oriented to face each other with a gap 585, simulating a scenario where the battery-powered devices are in close proximity to the wireless charging station, with only a shell separating them. The gap 585 between the transmitter coil main area 530 and the receiver coil main area 570 may be smaller than the gap 585 between the transmitter coil end-winding regions 535, 537 and the receiver coil end-winding regions 575, 577.

The arrows from the transmitter section 510 to the receiver section 550 outline the primary route through which the majority of power is transferred. Although some coupling exists in the transmitter and receiver coil end-winding areas 535, 537, 575, 577 it lacks reinforcement from the transmitter and receiver magnetic cores 540, 580 and is also considerably more distant from each other in comparison to the transmitter and receiver coil main areas 530, 570. Consequently, the coupling in the transmitter and receiver coil end-winding areas 535, 537, 575, 577 is relatively weak and can be regarded as negligible when contrasted with the transmitter and receiver coil main areas 530, 570. Thus, the transmitter coil main areas 530 of the transmitter coil 520 are oppositely facing and aligned with the receiver coil main areas 570 of the receiver coil 560.

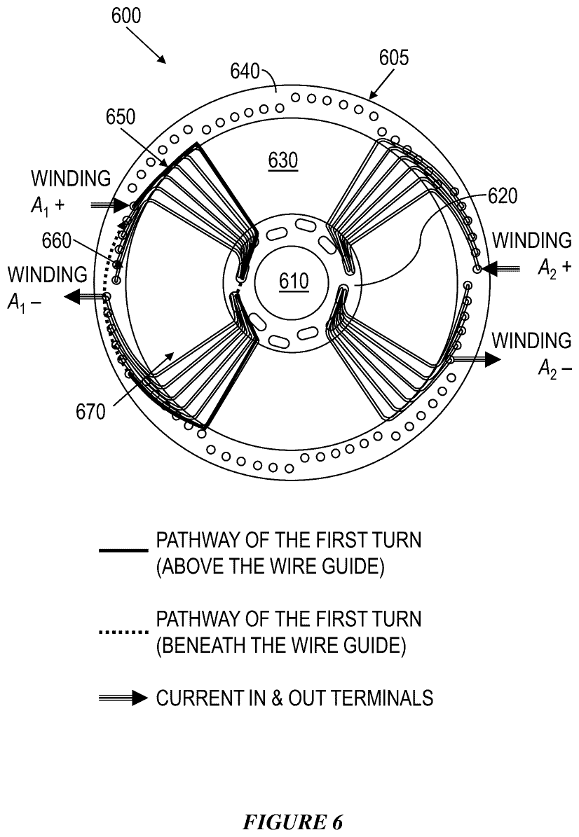

FIG. 6 illustrates an isolated top view of phase winding A of a multi-phase coil configuration 600 of a power supply of a wireless power transfer system. Analogous to FIGS. 4 and 5, the multi-phase coil configuration 600 includes main and auxiliary areas. The auxiliary area includes a central region 610 that serves as a docking area, and end-winding regions (inner end-winding regions 620 and an outer end-winding regions 640) that flank (surround or border) the main area 630. The phase winding A includes two distinct phase windings denoted as A₁ and A₂. To clarify its structure, a conduction path 650 is depicted as a solid line above a wire guide 605 to represent the first turn of the phase winding A₁. The conduction path 650 starts at a terminal labeled “A₁+” and follows a path through the outer end-winding area 640, the main area 630, the inner end-winding area 620, the main area 630 once again, and then the outer end-winding area 640 before concluding at the starting point of the second turn.

As illustrated, subsequent turns of the phase winding A₁ follow a similar pattern. The entire series of turns in the phase winding A₁ culminates a terminal labeled “A₁−”. A conduction path 660 is depicted as a dashed line representing a pathway of the first turn beneath the wire guide 605. A current path 670 is depicted as a solid line with arrows representing the current in and out of the terminals A₁+, A₁−.

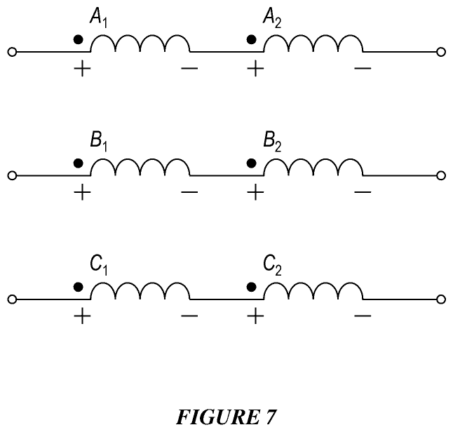

With continuing reference to FIG. 6, FIG. 7 illustrates a schematic diagram demonstrating a series combination of the phase windings A, B, and C. The “A₁−” terminal is connected to “A₂+”. Consequently, terminals “A₁+” and “A₂−” of phase winding A are to be connected to a compensating network. The connection pattern remains consistent for other phase windings, including phase windings B and C.

An analysis of the mutual inductance follows. Subscripts A, B, and C denote the phase windings of the transmitter, and subscripts a, b, and c represent the phase windings of the receiver. As such, the self-inductances of the transmitter phase windings can be denoted as L_{A}, L_{B}, and L_{C}, while the self-inductances of the receiver phase windings can be represented as Lₐ, L_{b}, and L_{c}. The angle θ signifies the misalignment angle, where it is important to note that when the coils are perfectly aligned, θ=0°. It is also assumed that the WPTS works under a three-phase balanced condition.

Consider the aligned condition, there exists the maximum mutual inductances between corresponding transmitter and receiver phase windings, namely M_{Aa,0°}, M_{Bb,0°}, and M_{Cc,0°}. Because the three-phase WPT coil is symmetrical, denote the maximum mutual inductance M₀ as equation (1).

$${M}_{Aa , {0}^{0}} = {M}_{Bb , {0}^{0}} = {M}_{Cc , {0}^{0}} = {M}_{0} \qquad ( 1 )$$

Also, introduce the mutual inductance sub-matrices Mₜᵣ and Mᵣₜ as described in equation (2), where the subscript t indicates the transmitter and r indicates the receiver.

$${M}_{tr} = {M}_{rt}^{T} = [ \begin{matrix}{M}_{Aa} & {M}_{Ab} & {M}_{Ac} \\ {M}_{B a} & {M}_{B b} & {M}_{B c} \\ {M}_{Ca} & {M}_{Cb} & {M}_{Cc}\end{matrix} ] \qquad ( 2 )$$

Because of the geometric structure of the proposed coil, when a misalignment angle θ is present, matrix Mₜᵣ is depicted in equation (3).

$${M}_{0} [ \begin{matrix}cos ( θ ) & cos ( θ + 120 ° ) & cos ( θ - 120 ° ) \\ cos ( θ - 120 ° ) & cos ( θ ) & cos ( θ + 120 ° ) \\ cos ( θ + 120 ° ) & cos ( θ - 120 ° ) & cos ( θ )\end{matrix} ] \qquad ( 3 )$$

Next, Vₐ, V_{b}, and V_{c} are defined as the induced voltages on receiver phase windings a, b, and c. Also, I_{A}, I_{B}, and I_{C} are defined as the current of transmitter phase windings A, B, and C, respectively. In the context of a three-phase balanced system, equations (4) through (6) are valid.

$${I}_{A} = {I}_{m} cos ( ω t ) \qquad ( 4 )$$

$${I}_{B} = {I}_{m} cos ( ω t - 120 ° ) \qquad ( 5 )$$

$${I}_{C} = {I}_{m} cos ( ω t + 120 ° ) \qquad ( 6 )$$

Here, Iₘ represent the magnitude of the transmitter phase winding current. Therefore, equation (7) can be used to express the amplitude of the induced voltage across the receiver phase windings.

$$[ \begin{matrix}{V}_{a} \\ {V}_{b} \\ {V}_{c}\end{matrix} ] = ω {M}_{tr} [ \begin{matrix}{I}_{A} \\ {I}_{B} \\ {I}_{C}\end{matrix} ] \qquad ( 7 )$$

After simplifying equation (7), equations (8) through (10) are the expressions of receiver phase winding induced voltages.

$${V}_{a} = 1.5 ω {M}_{0} {I}_{m} cos ( ω t - θ ) \qquad ( 8 )$$

$${V}_{b} = 1.5 ω {M}_{0} {I}_{m} cos ( ω t - θ - 120 ° ) \qquad ( 9 )$$

$${V}_{c} = 1.5 ω {M}_{0} {I}_{m} cos ( ω t - θ + 120 ° ) \qquad ( 10 )$$

It is noteworthy that the induced voltages Vₐ, V_{b}, and V_{c} share the same amplitude of 1.5 ωM₀Iₘ, and maintain a consistent phase shift of 120° between them. Hence, this mathematical analysis affirms that the proposed coil design can uphold a steady receiver voltage and phase shift, irrespective of the misalignment angle θ.

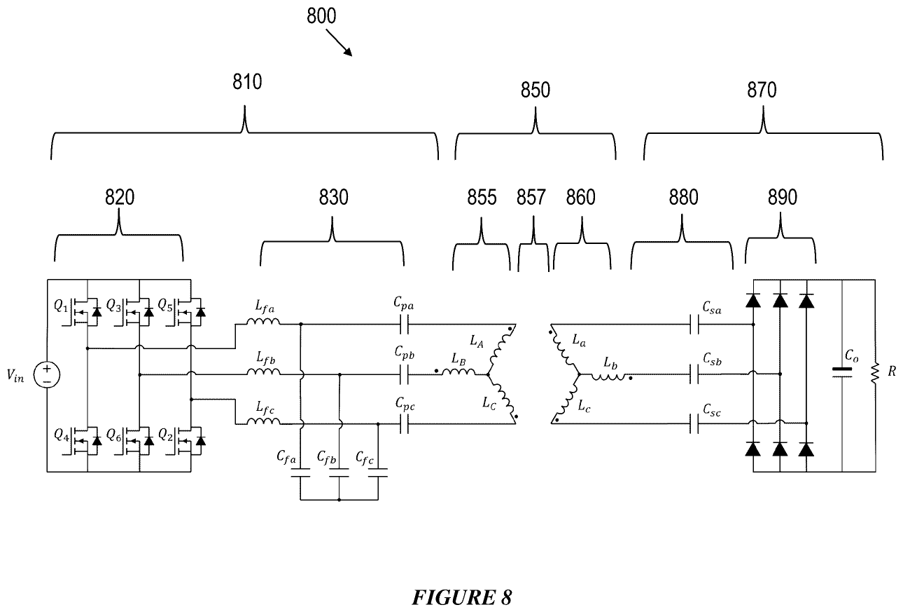

FIG. 8 illustrates a power supply 800 of a wireless power transfer system. The power supply 800 includes a first section (also referred to as a “transmitter section”) 810 and a second section (also referred to as a “receiver section”) 870. The power supply 800 includes a three-phase LCC-S compensation topology (or circuit) for the multi-phase coil configuration 850. The multi-phase coil configuration 850 includes first (or transmitter) coil (or phase windings) 855 and second (or receiver) coil (or phase windings) 860 separated by a gap 857. Inductors L_{A}, L_{B}, and L_{C} represent the inductances of the transmitter phase windings 855, and inductors Lₐ, L_{b}, and L_{c} represent the inductors of the receiver phase windings 860.

Vᵢₙ represents the dc bus input voltage. The MOSFETs Q₁, Q₂, Q₃, Q₄, Q₅, Q₆ form a three-phase inverter 820. The LCC-S compensation circuit includes a first (or transmitter) LCC-S compensation circuit 830 including compensation inductors L_{fa}, L_{fb}, L_{fc} and compensation capacitors C_{fa}, C_{fb}, C_{fc}, Cₚₐ, C_{pb}, C_{pc}. The LCC-S compensation circuit includes a second (or receiver) LCC-S compensation circuit 880, which is series compensated with compensation capacitors Cₛₐ, C_{sb}, C_{sc}. The receiver LCC-S compensation circuit 880 is coupled to a three-phase rectifier 890 and a resistive load R.

Understanding the resonant conditions of the LCC-S compensation circuit assist with calculating the values of compensation components. Equations (11) through (14) should be satisfied to meet the resonant condition of the transmitter LCC-S compensation circuit 830.

$$ω {L}_{fa} = \frac{1}{ω {C}_{fa}} , ω {L}_{fb} = \frac{1}{ω {C}_{fb}} , ω {L}_{fc} = \frac{1}{ω {C}_{fc}} \qquad ( 11 )$$

$$ω ( {L}_{A} - {M}_{interphase} - {L}_{fa} ) = \frac{1}{ω {C}_{pa}} \qquad ( 12 )$$

$$ω ( {L}_{B} - {M}_{interphase} - {L}_{fb} ) = \frac{1}{ω {C}_{pb}} \qquad ( 13 )$$

$$ω ( {L}_{C} - {M}_{interphase} - {L}_{fc} ) = \frac{1}{ω {C}_{pc}} \qquad ( 14 )$$

Similarly, equations (15) through (17) should be satisfied to meet the resonant condition of the receiver LCC-S compensation circuit 880.

$$ω ( {L}_{a} - {M}_{interphase} ) = \frac{1}{ω {C}_{s a}} \qquad ( 15 )$$

$$ω ( {L}_{b} - {M}_{interphase} ) = \frac{1}{ω {C}_{s b}} \qquad ( 16 )$$

$$ω ( {L}_{c} - {M}_{interphase} ) = \frac{1}{ω {C}_{s c}} \qquad ( 17 )$$

Here, the Mᵢₙₜₑᵣₚₕₐₛₑ represents the mutual inductances between transmitter phase windings 855 or receiver phase windings 860. For instance, M_{AB}, M_{BC}, and M_{ab} serve as examples of interphase mutual inductances.

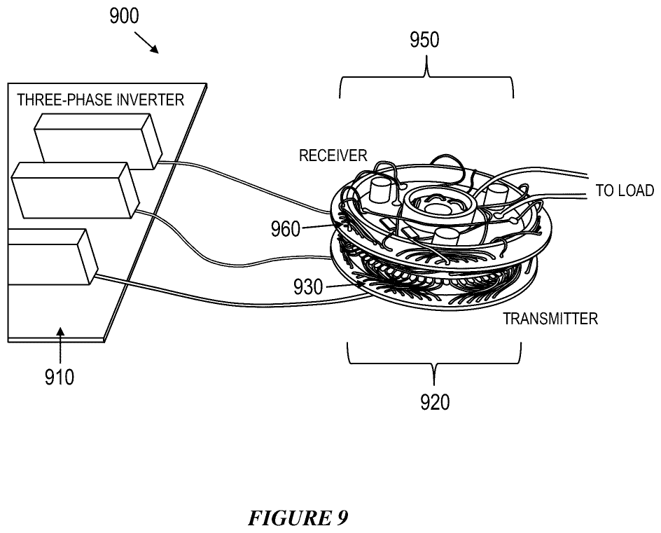

FIG. 9 illustrates a view of a multi-phase coil configuration of a power supply 900 of a wireless power transfer system. The power supply 900 includes a three-phase inverter 910 as an input to the first (or transmitter) section 920 with the first (or transmitter) coil 930 and a second (or receiver) section 950 with the second (or receiver) coil 960 as an input to a load.

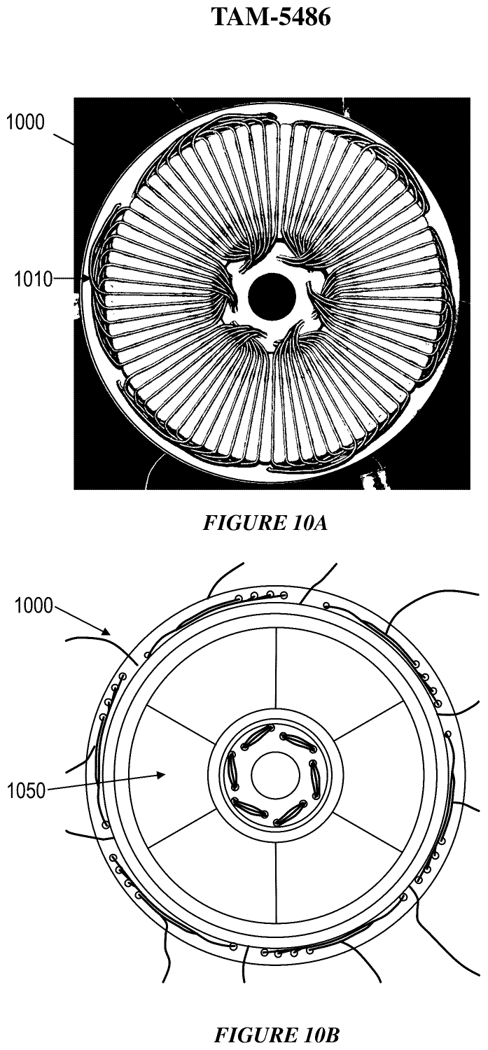

FIGS. 10A and 10B illustrate a top view and bottom view, respectively, of a multi-phase coil configuration 1000 of a power supply of a wireless power transfer system. FIG. 10B reveals a ring-shaped magnetic core 1050 positioned beneath the phase windings 1010 (FIG. 10A). Returning to FIG. 9, the receiver coil 960 is able to rotate, introducing a misalignment angle θ. The LCC-S compensation circuit of the power supply 800 described with respect to FIG. 8 is implemented positioned adjacent to the magnetic core. This placement takes advantage of the available ring-shaped space. Example WPTS's specifications are detailed in TABLE I.

TABLE I

| Parameters | Values | |
|---|---|---|
| DC bus voltage Vᵢₙ | 118 | V |
| Switching frequency f_{sw} | 85 | kHz |
| Output filter capacitance Cₒ | 68 | μF |
| Load resistance R | 70 Ω ± 5% | |
| Rated output voltage when aligned Vₒ | 150 | V |

Typically, an inductance matrix includes self-inductances and mutual inductances among them. In this case, the inductance matrix for the WPTS is specified in equation (18). It is worth noting that sub-matrices Mₜᵣ and Mᵣₜ, defined in equation (2), are dependent on the misalignment angle θ. Thus, they are expressed as Mₜᵣ(θ) and Mᵣₜ(θ). However, the self-inductances L_{A}˜L_{c} and interphase mutual inductances Mᵢₙₜₑᵣₚₕₐₛₑ remain constant and do not vary with changes in the misalignment angle θ.

$$[ \begin{matrix}\begin{matrix}{L}_{A} & {M}_{AB} & {M}_{AC} \\ {M}_{BA} & {L}_{B} & {M}_{BC} \\ {M}_{CA} & {M}_{CB} & {L}_{C}\end{matrix} & {M}_{tr} ( θ ) \\ {M}_{rt} ( θ ) & \begin{matrix}{L}_{a} & {M}_{ab} & {M}_{ac} \\ {M}_{ba} & {L}_{b} & {M}_{bc} \\ {M}_{ca} & {M}_{cb} & {L}_{c}\end{matrix}\end{matrix} ] \qquad ( 18 )$$

Example measurements set forth in equation (19) for the inductance matrix (18), as outlined below.

$$[ \begin{matrix}\begin{matrix}20.94 & - 5.76 & - 5.36 \\ - 5.76 & 21. & - 5.35 \\ - 5.36 & - 5.35 & 20.52\end{matrix} & {M}_{tr} ( θ ) \\ {M}_{rt} ( θ ) & \begin{matrix}20.93 & - 5.41 & - 5.43 \\ - 5.41 & 20.53 & - 5. \\ - 5.43 & - 5. & 20.18\end{matrix}\end{matrix} ] μH \qquad ( 19 )$$

The data provided in equation (19) offers adequate information to calculate the values of components within the LCC-S compensation circuit, in accordance with equations (11) to (17). The values of compensation components are listed in TABLE II, where the abbreviated notation L_{fa,b,c} refers collectively to inductors L_{fa}, L_{fb}, and L_{fc}. This notation rule is applied consistently throughout the table.

TABLE II

| Parameters | Theoretical | | | Experimental | | |
|---|---|---|---|---|---|---|
| L_{fa, b, c} (μH) | 13 | 13 | 13 | 13.1 | 13 | 12.8 |
| C_{fa, b, c} (μF) | 0.27 | 0.27 | 0.27 | 0.268 | 0.268 | 0.268 |
| C_{pa, b, c} (μF) | 0.268 | 0.268 | 0.268 | 0.268 | 0.268 | 0.268 |
| C_{sa, b, c} (μF) | 0.135 | 0.135 | 0.135 | 0.133 | 0.133 | 0.133 |

FIG. 11 illustrates a graphical representation of mutual inductances M_{Aa}, M_{Ab}, and M_{Ac}. The design of the multi-phase coli configuration is meant to ensure a stable output voltage, regardless of the misalignment angle θ. To achieve this, based on the mathematical derivations presented from equations (1) to (10), the mutual inductance sub-matrix Mₜᵣ should exhibit a sinusoidal pattern. For instance, regarding to the misalignment angle θ, mutual inductances M_{Aa}, M_{Ab}, and M_{Ac} should be like three-sinusoidal waveforms: cos(θ), cos(θ+120°, and cos(θ−120°. These three-phase sinusoidal mutual inductances verify the pattern described in equation (3).

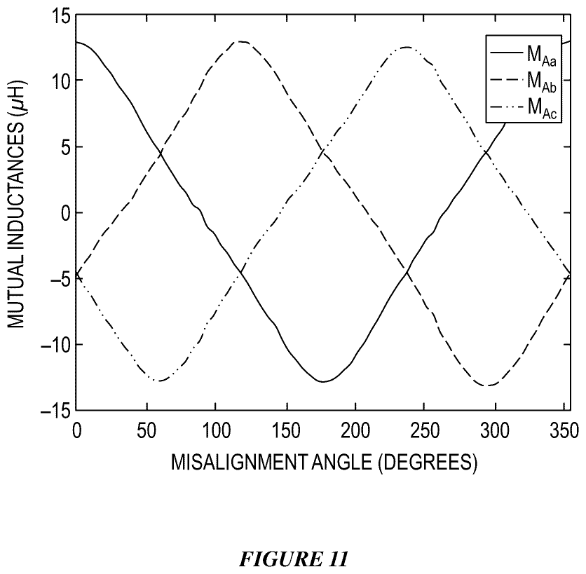

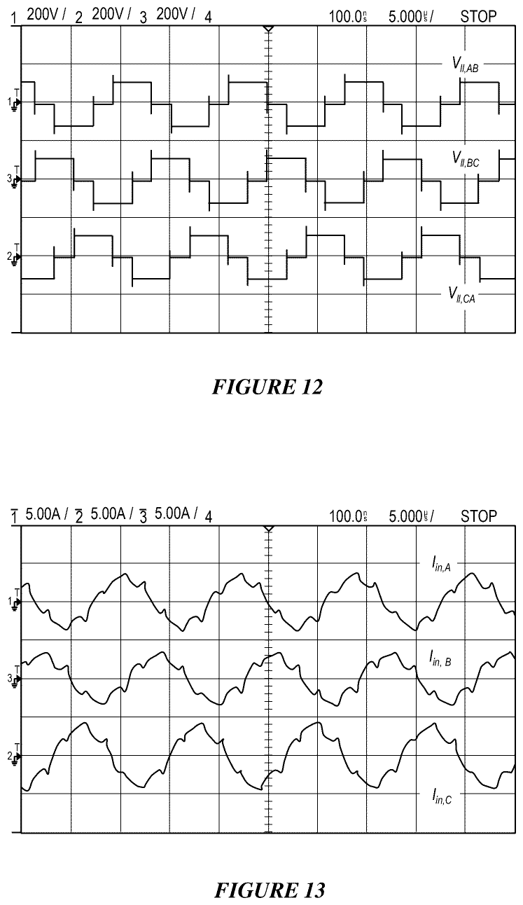

FIG. 12 illustrates a graphical representation of the inverter output voltages, which also correspond to the input line-to-line voltages of the transmitter's inductor-capacitor-capacitor to series compensation circuit. The three-phase inverter operates with a six-step modulation, featuring a 120-degree phase shift. FIG. 13 illustrates a graphical representation of the input currents of the transmitter's inductor-capacitor-capacitor to series compensation circuit.

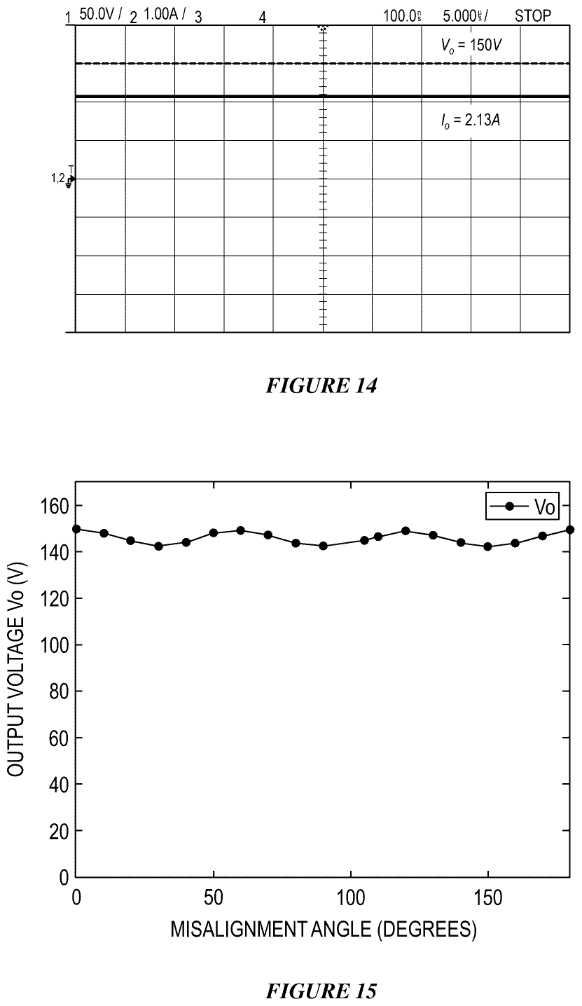

FIG. 14 illustrates a graphical representation of dc load voltage (output voltage) and current when the wireless power transfer system is in the aligned condition. The output voltage attains the specified output voltage of 150 volts (“V”). It is important to confirm the ability of the output voltage to remain stable when a rotational misalignment angle is introduced. Multiple tests were conducted to measure the output voltages. The fluctuation in the output voltage is depicted in FIG. 15.

In these measurements, the most challenging misalignment scenarios were observed when the misalignment angle was set at 30°, 90°, and 150°. The output voltage ranged from a maximum of 150 V to a minimum of 142.5 V. In comparison to the rated output voltage of 150 V, the minimum output voltage exhibited a five percent reduction in voltage. The system efficiency in the aligned condition is determined to be 90.5%. Under the most severe misalignment conditions, the efficiency is calculated to be 89.8%. The system efficiency remains relatively consistent across various misalignment angles.

The WPTS introduces a rotational misalignment resistant multi-phase coil configuration coil for battery-powered devices. The coil configuration results in a sinusoidal pattern in the mutual inductances between the transmitter and receiver coils, thereby mitigating the impact of rotational misalignment. The multi-phase coil configuration is complemented with an LCC-S compensation circuit. In the presence of rotational misalignment, the maximum reduction in output voltage remains under five percent.

Thus, multi-phase wireless power transfer systems and methods of operating the same have been introduced herein. With reference to the FIGUREs, in one embodiment, a power supply (500, 800) of a wireless power transfer system includes a first section or transmitter section (510, 810) couplable to a source of electrical power (Vᵢₙ), and includes a first compensation circuit (830), and a first coil (520, 855) of a multi-phase coil configuration (850) and having a first coil main area (530). The power supply (500, 800) also includes a second section or a receiver section (550, 870) including a second coil (560, 860) of the multi-phase coil configuration (850) separated from the first coil (520, 855) by a gap (585, 857) and having a second coil main area (570). The second coil main area (570) is oppositely facing and aligned (or substantially aligned) with the first coil main area (530) to allow (or enable) wireless power transfer from the first coil (520, 855) to the second coil (560, 860). The power supply (500, 800) also includes a second compensation circuit (880), and a rectifier (890) configured to provide direct current power to a load (R) such as batteries for a battery-powered device. The second section (550, 870) is oppositely oriented to the first section (510, 810) to reduce rotational misalignment between the first section (510, 810) and the second section (550, 870).

The first section (510, 810) may also include a first section magnetic core (540) under the first coil main area (530) and the second section (550, 870) may also include a second section magnetic core (580) under the second coil main area (570) to enhance coupling. The first compensation circuit (830) and the second compensation circuit (880) may form an inductor-capacitor-capacitor to series compensation circuit.

The first section (510, 810) may also include first coil auxiliary areas with first coil end-winding regions (535, 537) that flank (surround or border) the first coil main area (530) and the second section (550, 870) may also include second coil auxiliary areas with second coil end-winding regions (575, 577) that flank (surround or border) the second coil main area (570). The first coil end-winding regions (535, 537) include terminals for first coil phase windings in the first coil main area (530) and the second coil end-winding regions (575, 577) include terminals for second coil phase windings in the second coil main area (570). The gap (585, 857) between the first coil main area (530) and the second coil main area (570) may be smaller than the gap (585, 857) between the first coil end-winding regions (535, 537) and the second coil end-winding regions (575, 577). First coil phase windings in the first coil main area (530) partially overlap and second coil phase windings in the second coil main area (570) partially overlap. The first coil (520, 855) and the second coil (560, 860) may be in a ring-shaped configuration.

Although the embodiments and its advantages have been described in detail, it should be understood that various changes, substitutions, and alterations can be made herein without departing from the spirit and scope thereof as defined by the appended claims. Also, many of the features, functions, and steps of operating the same may be reordered, omitted, added, etc., and still fall within the broad scope of the various embodiments.

Moreover, the scope of the various embodiments is not intended to be limited to the embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

1. A power supply, comprising:
a first section couplable to a source of electrical power, comprising:
a first compensation circuit, and
a first coil of a multi-phase coil configuration and having a first coil main area; and
a second section, comprising:
a second coil of said multi-phase coil configuration separated from said first coil by a gap and having a second coil main area, said second coil main area oppositely facing and aligned with said first coil main area to allow wireless power transfer from said first coil to said second coil,
a second compensation circuit, and
a rectifier configured to provide direct current power to a load, said second section being of opposite orientation to said first section to reduce rotational misalignment therebetween.

2. The power supply as recited in claim 1 wherein said first section further comprises a first section magnetic core under said first coil main area and said second section further comprises a second section magnetic core under said second coil main area.

3. The power supply as recited in claim 1 wherein said first compensation circuit and said second compensation circuit form an inductor-capacitor-capacitor to series compensation circuit.

4. The power supply as recited in claim 1 wherein said first section further comprises first coil auxiliary areas with first coil end-winding regions that flank said first coil main area and said second section further comprises second coil auxiliary areas with second coil end-winding regions that flank said second coil main area.

5. The power supply as recited in claim 4 wherein said first coil end-winding regions comprise terminals for first coil phase windings in said first coil main area and said second coil end-winding regions comprise terminals for second coil phase windings in said second coil main area.

6. The power supply as recited in claim 4 wherein said gap between said first coil main area and said second coil main area is smaller than said gap between said first coil end-winding regions and said second coil end-winding regions.

7. The power supply as recited in claim 1 wherein first coil phase windings in said first coil main area partially overlap and second coil phase windings in said second coil main area partially overlap.

8. The power supply as recited in claim 1 wherein said first coil and said second coil are in a ring-shaped configuration.

9. The power supply as recited in claim 1 wherein first section is a transmitter section and said second section is a receiver section.

10. The power supply as recited in claim 1 wherein said load comprises batteries for a battery-powered device.

11. A method of operating a power supply, comprising:
coupling a first section to a source of electrical power, said first section comprising a first compensation circuit, and a first coil of a multi-phase coil configuration and having a first coil main area;
providing a second section comprising a second coil of said multi-phase coil configuration separated from said first coil by a gap and having a second coil main area, and a second compensation circuit;
reducing rotational misalignment by oppositely orienting said first section and said second section;
providing wireless power transfer from said first coil to said second coil by oppositely facing and aligning said second coil main area to said first coil main area; and
providing direct current power to a load.

12. The method as recited in claim 11 further comprises enhancing a coupling between said first section and said second section with a first section magnetic core under said first coil main area and a second section magnetic core under said second coil main area.

13. The method as recited in claim 11 wherein said first compensation circuit and said second compensation circuit form an inductor-capacitor-capacitor to series compensation circuit.

14. The method as recited in claim 11, further comprising:
surrounding said first coil main area with first coil auxiliary areas having first coil end-winding regions; and
surrounding said second coil main area with second coil auxiliary areas having second coil end-winding regions.

15. The method as recited in claim 14, further comprising:
coupling first coil phase windings in said first coil main area to terminals in said first coil end-winding regions; and
coupling second coil phase windings in said second coil main area to terminals in said second coil end-winding regions.

16. The method as recited in claim 14 wherein said gap between said first coil main area and said second coil main area is smaller than said gap between said first coil end-winding regions and said second coil end-winding regions.

17. The method as recited in claim 11, further comprising:
partially overlapping first coil phase windings in said first coil main area; and
partially overlapping second coil phase windings in said second coil main area.

18. The method as recited in claim 11 wherein said first coil and said second coil are in a ring-shaped configuration.

19. The method as recited in claim 11 wherein first section is a transmitter section and said second section is a receiver section.

20. The method as recited in claim 11 wherein said load comprises batteries for a battery-powered device.
